(19) United States
(12) Patent Application Publication
(10) Pub. No.: US 2008/0003389 A1
(43) Pub. Date: Jan. 3, 2008

(54) COMPOSITE TUBE WITH A DEFORMABLE LINING

(75) Inventors: Nils HOFFMANN, Attendorn (DE); Oscar Hernandez ARAGON, Schmallenberg-Bad Fredeburg (DE); Manfred KONIG, Attendorn (DE); Bernd KOSCHIG, Attendorn (DE); Carsten SCHMITZ, Attendorn (DE); Mike AHMANN, Attendorn (DE); Ralf HEUEL, Attendorn (DE); Andreas SCHNEIDER, Finnentrop-Schonholthausen (DE)

Correspondence Address: PROSKAUER ROSE LLP, ONE INTERNATIONAL PLACE, BOSTON, MA, 02110, US

(73) Assignee: VIEGA GMBH & CO. KG, Attendorn (DE)

(21) Appl. No.: 11/736,455

(22) Filed: Apr. 17, 2007

(30) Foreign Application Priority Data
Apr. 19, 2006 (DE) 102006018466.1-24

(51) Int. Cl. B32B 1/08

(52) U.S. Cl. 428/36.1; 428/34.1; 428/36.8

(57) ABSTRACT

A composite tube includes at least two linings, wherein the first lining is an inert lining and wherein the second lining is placed radially outside of the first lining. A technical goal is to make available a composite tube, which provides an inert conduit for the transported medium and which, upon bending, does not prematurely kink itself. This technical goal is achieved in that a third deformable lining is provided and in that the third lining is placed radially outside of the first lining and is bound to the intervening second lining.

The invention concerns a composite tube, having at least two layers of linings, wherein the most inward first lining is an inert material and wherein the second lining is placed successively next outward of the said first lining.

Composite tubing of known types follow the state of technology. During the forming of a tube, wherein the tube is to be classified as a composite tube, it is necessary, that the various requirements of materials defining a composite tube must be applied to at least two coaxial linings.

Accordingly, for the most inward first lining, chemically inert characteristics, that is to say, materials which repel the migration of unwanted additives, are highly desirable. Conversely, in regard to the radially outward lining, anticorrosion properties and physical resistance characteristics are looked for, especially with consideration given to conditions of temperature, chemical properties, or cross-linkage caused by electron radiation, particularly concerning plastic lining material and properties of transported substances. Such plastic materials are known in the industrial world as PEX-A, PEX-B or PEX-C.

In the case of the production of cross-linked plastics, side products accumulate. Where PEX-A plastics are involved, the said accumulation is governed by high temperatures necessary to effect cross-linking action. With PEX-B plastics, the side product generation is due to the chemical materials applied to effect the cross-linking. Where PEX-C plastics are concerned, conversion products from electron radiation occur. Further, the above mentioned plastics are frequently subjected to higher stabilization concentrations, in order to compensate for losses encountered in the cross-linking operation. These stabilization materials, also known hereinafter as “additives” can likewise migrate into the medium transported by the composite tube and during this action, may reactively convert to unwanted substances. Commercial plastics are permitted, generally, to contain some 5% of additive materials. Obviously, it is also possible that the content of additives can be chosen optionally to be more or less than stated, depending upon the desired characteristics of the plastics used for linings.

The first lining acts as a protective coating, in order to protect the medium being transported in the composite tube from receiving a migration of materials embedded in the second lining

Most particularly, if the transported medium in the tube is potable water, the possibility exists that undesirable substances, such as the said additives, can migrate into the said water.

The previously discussed composite tubes have the disadvantage, that they exhibit very poor bending characteristics. Particularly, the known tubes, when bent, have a tendency to kink, in such a manner that the transported medium is disadvantageously restricted by the restriction of a free-flow cross-section.

Thus the present invention has the purpose, of meeting the above indicated technical problem by making available a composite tube, which presents an inert contact to the transported medium and when bent, does not prematurely kink.

In accord with the invention, the said technical problem is solved, in that a third and especially a deformable lining is provided and in that this third lining is placed radially outside first lining and is securely bound to the third lining.

Thus the present invention provides, that a deformable third lining stabilizes and supports the cross-section of a composite tube at its location of bending and in this way, avoids a premature kinking of the tube.

In considering the bending of a composite tube, the bending radius is measured from its beginning at the centerline of the tube. Normally, the minimal bending radii lie in a range between 1.5 and 5 times the outside diameter of the composite tube. This range can be dependent upon whether or not the tube is being bend by hand or by equipment for the purpose. If an invented composite tube be bent, then those parts of the composite tube which lie within the radius of bending are compressed. Those parts of the composite tube which lie outside of the bending radius are correspondingly subjected to tension. The third deformable lining can shape itself plastically and thus compensate for the said internal stresses of the tube, namely the compressing and the tensioning. In this way, the composite tube retains its roundness of cross-section to the greatest possible extent. The linings, which are bound with the said third lining likewise experience the said compression and stretching. Thus, in these linings stresses arise, which, cannot fall into a kinking mode, because the stress loaded linings are compensated by the described third deformable lining to which they are bound.

In one embodiment example, it is possible that the first lining may be of metal, for instance the metal could be stainless steel, such as a chrome-nickel alloy, or yet may be titanium. Thereby it is possible that the especially advantageous characteristics of stainless steel could be employed for the transport of drinking water.

The first lining can be, or can incorporate, a thin tube with a wall thickness running in the range of possibly a few tenths or hundredths of a millimeter, for instance one-tenth of a millimeter could be preferred. The said thin tube, which serves as the said first lining, can be made by known manufacturing processes. Especially the joining seams of this thin tube can be of over-lapping construction or be welded end to end. The thin tube, in order to be the first lining, during manufacture of the composite tube, can possibly be placed coaxially within the second lining, during the extruding of the latter.

Alternately, the first lining can be created by a physical deposition procedure, especially if the material thereof is polyvinylidene. This method is best carried out immediately following the extruding of the second lining.

The first lining can consist of, for example, the following plastics:

PSU polysulfone

PPSU polyphenylsulfone

PVDF polyvinylidene fluoride and

PTFE polytetrafluoroethylene, otherwise known by the trade name “Teflon”.

Thus one possibility is, that plastics can be used advantageously as inert barrier layers. Obviously, it is also possible, that other, diffusion free substances can be used for the composition of the first lining. Ceramics, glasses, and especially any additive free, impermeable plastic are not excluded for this service.

A particularly advantageous embodiment example is therein characterized, in that the second lining can consist of a plastic, including:

PE polyethylene

PERT polyethylene, heat resistant

PEX polyethylene, cross-linked

PP polypropylene

PB polybutene

PA polyamide

PVC polyvinyl chloride

wherein these materials, whether can be manufactured as filled, unfilled, or reinforced plastics. In this manner, the most favorable material characteristics of the said plastics may be made available for the manufacture of the composite tube components.

In one embodiment, the third lining can be made of a metal, especially aluminum, steel or copper. In such a case, the deformation character of the third lining will be enhanced by the ductility of the selected metal.

One possibility for bonding the third lining with second lining arises, in a procedure wherein the third lining is pressed into the second lining. Alternately, it is possible, that the third lining can be integrated into the second lining by a melting process. Thereby, the third lining can be bonded onto, or implanted within, the second lining immediately following the extrusion of the said second lining. This last named procedure can be accomplished either by a partial congealment of the melt for the second lining, which then leads to a bonding by full fusion. Alternately, a bonding made after a partial congealment of the melt can aid in accomplishing a pressure based joining of the linings.

The third lining can be a continuous or an intermittent run of lining. Especially, in the case of the said intermittent lining, the third lining material can be applied as a netting, a perforated sheet, a fibrous surface, a fabric-like surface, a mesh, or as various textured type surfaces, or even as a spiral winding. These methods allow the above mentioned pressure or melting methods to be effectively adapted to bonding between the third and the second linings.

An additional embodiment example is therein characterized, in that a fourth lining can be applied as a external, plastic, covering shell, similar to a lacquering or coating application. Thus it is possible that those linings which are radially within this external fourth lining are protected from damages or other external harmful actions, such as, for example, ultraviolet radiation. Furthermore, in this way, by means of the said fourth lining, the external surface of the invented composite tube can endure environmentally ambient challenges, independently of properties of the inner linings.

The interconnection of the different linings can additionally be achieved, in that between two linings an adhesive layer can be placed. Thus, such a bonding between two linings can be defined as particularly exact and endurable.

In the following, the invention, with the aid of selected embodiment examples will be explained and described on the basis of the attached illustrations. There is shown in:

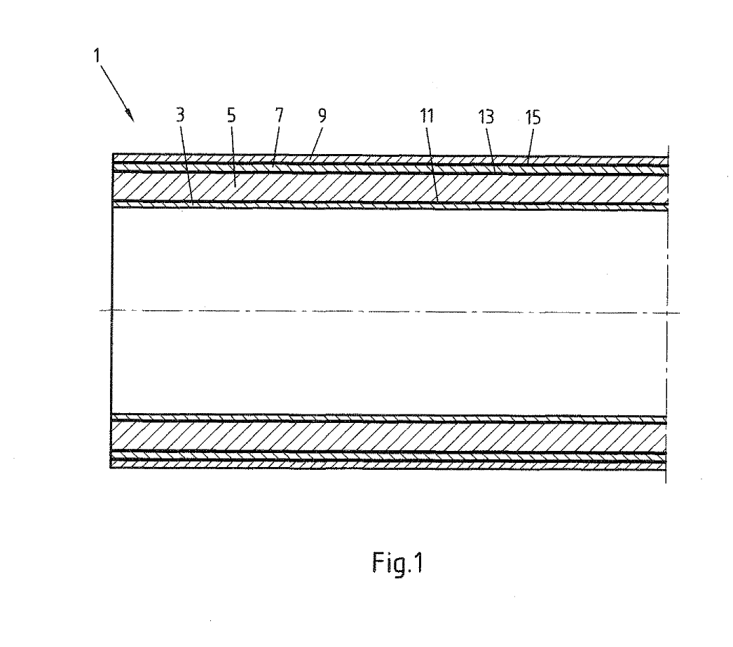

FIG. 1 an invented composite tube

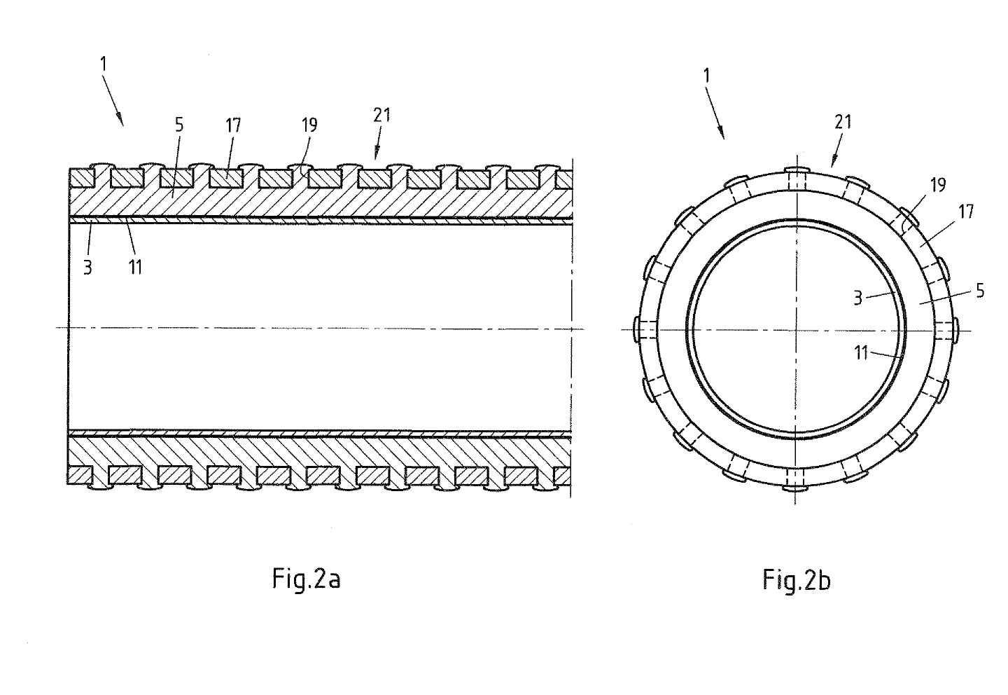

FIG. 2 an additional embodiment of an invented composite tube, and

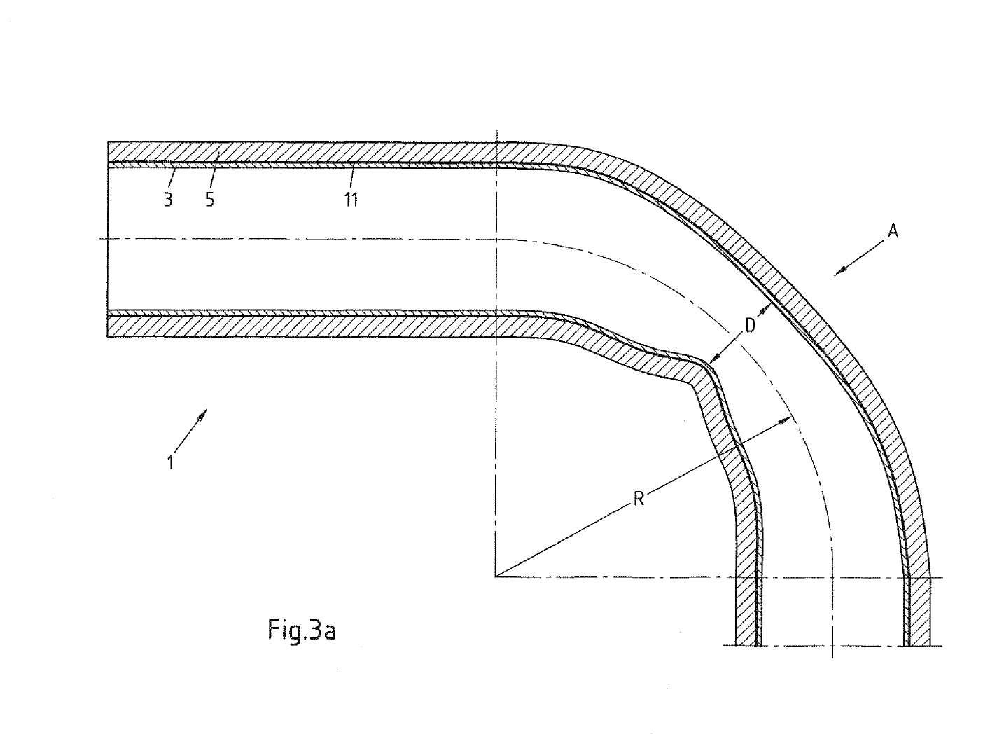

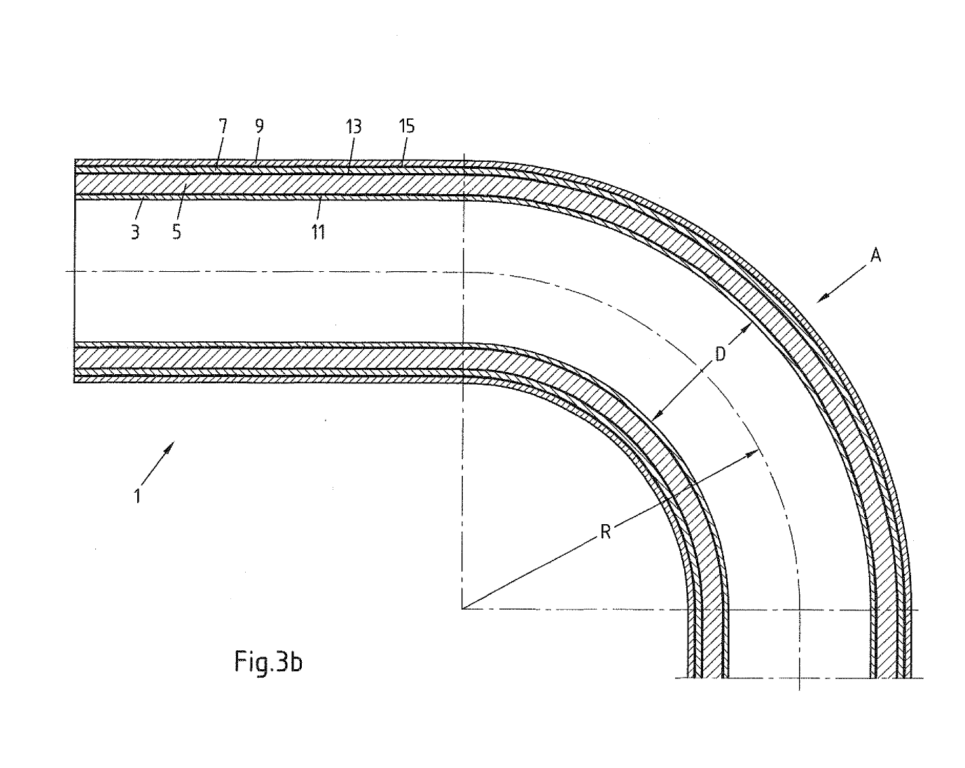

FIG. 3 a bent composite tube without and with a deformable lining.

FIG. 1 shows a longitudinal cross-section of an invented composite tube 1, with four linings, wherein the first lining 3 is an inert lining and wherein the second lining 5 is placed radially outside of the first lining 3.

In accord with the invention, a premature kinking of the composite tube 1 is prevented, in that a third deformable lining 7 is provided, which is located radially outward of the first lining 3 and said deformable lining 7 is bonded to the intervening second lining 5.

The first lining 3, shown in FIG. 1, may consist of a metal, this possibly being a stainless steel having a wall thickness of 0.1 mm.

Alternatively, it is possible that the first lining 3 could also consist of a plastic material, for instance, PSU, PPSU, PVDF or PTFE.

In the case of the embodiment example shown in FIG. 1, the second lining 5 is made of a plastic, especially this being PE, PERT, PEX, PP, PB, PA or PVC which can be provided in a filled or unfilled or reinforced form.

The third lining 7, as seen in the embodiment example in FIG. 1, can consist of a metal, namely aluminum, steel or copper.

The previously described, invented composite tube 1 can possess, besides the above mentioned three linings, an additional lining, this being a fourth lining 9, which is to serve as the outermost protective covering of plastic.

For the bonding of the cited linings, one to the next, of the composite tube shown in FIG. 1, a layer of an adhesive substance serves, respectively, between the linings 3 and 5, 5 and 7 as well as between the linings 7 and 9. The subject adhesive layers carry, respectively, reference numbers 11, 13, and 15.

FIG. 2a exhibits an alternative embodiment example. First, as in the above described embodiment example, is shown an inert, first, innermost lining 3 as well as a second, radial outward lining 5. The two linings 3 and 5 are bound together by an adhesive layer 11. A third lining, designated as 17, is shown in FIG. 2a as an intermittently broken lining. The third lining 17 is depicted in a net shape, and possesses the network openings 19.

Where the embodiment shown in FIG. 2a is concerned, the said second lining 5 extends itself through the said openings 19 to reach the outside surface 21 of the third lining 17. In this way, an effective bonding between second lining 5 and the third lining 17 is achieved. The lining 17 can be entirely encapsulated by the lining 5, either by means of depressing the lining 17 into a melt of lining 5 or by employing two separate extrusion procedures with the same material, between the openings of which, the protective lining 17 will be inserted.

FIG. 2b clarifies the exemplary, circumferential apportionment of the intervals 19 about the composite tube as well as the penetration of the lining 5 to the external surface of the lining 17.

Such a penetration can be achieved, wherein the third lining 17 becomes melted into the second lining 5. Particularly advantageous would be a procedure, in which the lining 5, in a non-yet solidified state, would be used to fulfill the penetrative connection in an extrusion process.

A further possibility also exists, wherein the third lining 17 is pressed into the second lining 5. With respect to the application requirements and the manufacturing process, several alternatives present themselves as choices for the connection of the linings. Obviously, other formations of the layer 17 are possible. For instance, a spiral winding and/or other connective variants between the linings can be selected.

It is also possible, that the lining 17 can be subjected to a preliminary surface treatment with an appropriate primer, which is applied upon the material of which lining 5 consists, to the end that a satisfactory shape and force fit bonding between the linings 5 and 17 can be acquired.

FIG. 3a presents a composite tube 1 in conformity with the state of the technology. This said tube possesses an inert lining 3 as well as a plastic lining 5, which are bound together with a layer of an adhesive agent 11. In the case of a bending of the composite tube 1, wherein the bending radius is, as marked, R, those increments of the composite tube 1, which lie inside the said radius R of bending, experience a compressing stress. Simultaneously, the increments of the composite tube 1, which lie outside of the said radius R of bending, are subjected to tensioning. Since the linings 3 and 5 cannot physically deform in a deformable manner, and cannot, accordingly, either lengthen nor shorten themselves, the described stresses cannot be overcome by counter forces and consequently the illustrated composite tube must deform at the point A. The result is a kinking at point A. The linings 3 and 5 then find themselves in a stress-free condition, which is attained by the said kinking. This leads to an accompanying restriction of the diameter D of the composite tube 1 at the kinking point A.

In FIG. 3b is presented a composite tube 1 in accord with the present invention which said tube possesses an inert lining 3, a plastic lining 5, a deformable lining 7 and a protective outer cover 9. The said linings are successively bonded by layers of an adhesive agent, namely layers 11, 13, 15. In the case of a bending of the composite tube 1, as shown in FIG. 3b, wherein the bending radius is again R, once again those increments of the composite tube 1 which lie within the said bending radius R are subjected to compressive stress, while simultaneously, those increments of the composite tube 1 which lie outside of the bending radius R undergo tensioning forces.

The deformable lining 7 is accordingly deformed by the said stressing and finds itself thereafter in a stress-free condition. On the outside of the bending radius R, the deformable lining 7 lengthens itself, while the inward lining shortens itself. As a result, the deformable lining 7 retains its circumferential shape. The additional, linings 3, 5 and 9 of the composite tube, which are under bending stress, are supported by their connection to the deformable lining 7. Thereby a kinking at the location A of the composite tube 1 does not take place. Likewise, a constriction of the diameter D is, to the greatest possible extent, prevented.

Obviously, an invented composite tube is not limited to the above described embodiment examples. Especially for isolation and/or for the increasing of resistance capability when, for example, chemically aggressive surroundings are present, recourse may be found in adding additional linings.

By means of appropriate material combinations, it is additionally possible that a partial or total exclusion of the said adhesive agent layers can be achieved.

1. A composite tube, with at least two linings, wherein an innermost and first lining is an inert lining and whereby a second lining is place radially outside of the first lining,
and wherein a third, deformable lining is provided,
the third lining lies radially outside of the first lining and is bound with the second lining.

2. A composite tube, in accord with claim 1, wherein the first lining consists of a metal.

3. A composite tube, in accord with claim 1, wherein the first lining consists of a plastic.

4. A composite tube, in accord with claim 1, wherein the second lining consists of a plastic in an unfilled, filled or reinforced form.

5. A composite tube, in accord with claim 1, wherein the third lining, is comprised of a metal.

6. A composite tube, in accord with claim 1, wherein the third lining is pressed into the second lining.

7. A composite tube, in accord with claim 1, wherein the third lining is melted into the second lining.

8. A composite tube, in accord with claim 1, wherein the third lining is a continuous or an partially intermittent lining.

9. A composite tube, in accord with claim 1, wherein a fourth lining is provided as a covering plastic layer, which may be a lacquer or a coating.

10. A composite tube, in accord with claim 1, wherein between at least two successive linings, a layer of an adhesive agent is placed.

11. A composite tube, in accord with claim 2, wherein the metal of the first lining is selected from the group consisting of stainless steel and titanium.

12. A composite tube, in accord with claim 3, wherein the plastic of the first lining is selected from the group consisting of PSU, PPSU, PVDF and PTFE.

13. A composite tube, in accord with claim 4, wherein the plastic of the second lining is selected from the group consisting of PE, PERT, PEX, PP, PB, PA and PVC.

14. A composite tube, in accord with claim 5, wherein the metal of the third lining is selected from the group consisting of aluminum, steel and copper.

15. A composite tube, in accord with claim 8, wherein the third lining is made as a fabric, a mesh or as a web.
